(19) United States
(12) Patent Application Publication
(10) Pub. No.: US 2011/0082765 A1
(43) Pub. Date: Apr. 7, 2011

(54) METHOD AND SYSTEM FOR ITEM COLLECTION IN A SHOP

(76) Inventor: Yitzhak Mazor, Omer (IL)

(21) Appl. No.: 12/995,465

(22) PCT Filed: Jun. 9, 2009
(86) PCT No.: PCT/IB09/52439

§ 371 Date: Dec. 1, 2010

Related U.S. Application Data
(60) Provisional application No. 61/061,664, filed on Jun. 16, 2008.

(51) Int. Cl. G06Q 30/00

(52) U.S. Cl. 705/26.8

(57) ABSTRACT

A method for item collection in a shop in participation of a shopper and in support of computerized platforms. The method includes providing first and second shopping lists, supporting item collection by the shopper in accordance with the lists. The method may include providing an user interface to an item database and storage for shopping lists, facilitating division of a single shopping list into first and second shopping lists, comparing a shopping list with available items, and storing past shopping list. The shop may propose the.shopper buy an available item, encourage sale of the available item in replacement of an unavailable item, remind items based on past shopping lists and support a promotion campaign for the item. The shop may compose a suggestive shopping list, provide the shopping list on a hard copy or mobile device, and may provide the shopper data associated with item locations.

### CLAIM OF PRIORITY

This application claims the benefit of provisional U.S. application Ser. No. 61/061,664 entitled “A routine shopping list method and system” by the present inventor, filed Jun. 16, 2008.

### BACKGROUND OF THE INVENTION

1. Field of the Invention

The invention is in the field of consumer service, and especially relates to an efficient and personally matched process and system for customers making routine and other purchases at food chains.

2. Description of Related Art

Remote purchasing by telephone or by computer in grocery stores is known for many years. The client or shopper sends a list of items to the shop, item collection is made by a shop employee or associate, and the shop delivers the items or goods to the client's house. While remote purchasing is attractive to consumers unable to come to the shop, the method has some drawbacks. Sometimes an incorrect product or item is collected, or some items are missing. Besides, there are items like fruits and vegetables that the customer preferred to pick up to ensure freshness of the products. Another disturbing aspect of remote purchasing is the need to coordinate delivery time and wait to delivery. Also, returning items to the shop might cause the consumer to come to the shop anyhow.

Certain consumers or shoppers may take advantage of existing remote purchasing capabilities and order part of their shopping through such system, while leaving certain items for conventional shopping. It is an object of the present disclosure to provide a method and system to support such shoppers, especially in a mode of shopping whereas item collection by the shopper and by the shop associate are done at some temporal overlapping.

### BRIEF SUMMARY OF THE INVENTION

It is provided for the first time a method for item collection in a shop in participation of a shopper and in support of computerized platforms. The method includes providing a first shopping list and a second shopping list, supporting item collection by the shopper in accordance with the first shopping list, and collecting items in accordance with the second shopping list. The supporting is facilitated by the computerized platforms.

In some embodiments, the method includes providing an user interface to an item database and to a storage for shopping lists, whereby the storage may contain past and planned shopping lists of the shopper.

In some embodiments, the method includes facilitating division of a single shopping list into the first shopping list and the second shopping list.

In some embodiments, the method includes comparing a shopping list with a list of available items.

In some embodiments, the method further includes the step of storing a list of bought items in a storage for shopping lists as a past shopping list.

In some embodiments, the method includes proposing the shopper to buy an available item. Such a proposal may encourage sale of the available item in replacement of an unavailable item included in a shopping list. Also, it may remind items based on past shopping lists and/or support a promotion campaign for the item.

In some embodiments, the method includes providing at least one storage medium for storing a shopping list. The shopping list may be retrieved from the computerized platforms. Thus, the shopper may get the shopping list on an accessible medium for use while collecting items in the shop.

In some embodiments, the method includes composing a suggestive shopping list in accordance with past shopping lists.

In some embodiments, the method includes providing the shopper one or more data pieces associated with location of certain items.

In some embodiments, the method includes proposing the shopper to buy an available item in response to an item inquiry made by the shopper.

In some embodiments, the method includes adding unavailable items to a stock in accordance with expected visit time, planned shopping lists and past shopping list associated with a future visit of the shopper.

In some embodiments, the supporting of item collection by the shopper in accordance with the first shopping list, and the collecting of items in accordance with the second shopping list are temporally overlapping.

In some embodiments, the method includes designing the collecting items in accordance with the second shopping list to be substantially over once the item collection in accordance with the first shopping list is over. Thus, once the shopper arrives a cashier, the items collected for her/him are available for payment.

It is provided a program storage device readable by a computerized apparatus, tangibly embodying a program of instructions executable by the computerized apparatus to facilitate execution of the method for item collection in a shop in participation of a shopper and in support of computerized platforms.

It is provided for the first time, shopping assisting module for item collection in a shop in participation of a shopper. The module is associated with an item database, with a storage for shopping lists and with an user interface. The module is adapted for interacting with a shopper using the user interface to provide a first shopping list and a second shopping list, supporting item collection by the shopper in accordance with the first shopping list, outputting the second shopping list for use by an item collector.

In some embodiments, the module is further adapted to communicate with a mobile device in support of item collection by the shopper.

In some embodiments, the mobile device is a cellular telephone, a personal digital assistants (PDA), laptop computer, mobile media players, or a mobile device dedicated to assisting shoppers(PSA, personal shopping assistant).

In some embodiments, the mobile device is adapted to managing a shopping list.

It is provided for the first time, a mobile device for assisting a shopper in item collection in a shop in support of a computerized platform. The item collection by the shopper being made in temporal overlapping with item collection for the shopper by a shop associate. The mobile device is adapted for interacting with the computerized platform regarding shopping lists, item location, item selection by the shop associate, suggestion of available item in replacement of an unavailable item.

In some embodiments, the mobile device interacts with the computerized platform using a local area network.

### BRIEF DESCRIPTION OF THE DRAWINGS

The subject matter regarded as the invention is particularly pointed out and distinctly claimed in the concluding portion of the specification. The invention, however, both as to system organization and method of operation, together with features and advantages thereof, may best be understood by reference to the following detailed description when read with the accompanied drawings in which:

FIG. 1a illustrates a shop computing platform which includes a shopping assisting module for item collection in a shop in participation of a shopper.

FIG. 1b illustrates a shop computing platform directly linked to a shopping assisting module.

FIG. 1c illustrates a shop computing platform linked through a wide area network to a shopping assisting module.

FIG. 2 presents a flow chart of a method for item collection in a shop in participation of a shopper.

FIG. 3 presents a flow chart of a method for item collection in a shop in participation of a shopper.

### DETAILED DESCRIPTION OF THE INVENTION

The present invention will now be described in terms of specific example embodiments. It is to be understood that the invention is not limited to the example embodiments disclosed. It should also be understood that not every feature of the methods and systems handling the described device is necessary to implement the invention as claimed in any particular one of the appended claims. Various elements and features of devices are described to fully enable the invention. It should also be understood that throughout this disclosure, where a method is shown or described, the steps of the method may be performed in any order or simultaneously, unless it is clear from the context that one step depends on another being performed first.

Before explaining several embodiments of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Unless otherwise defined, all technical and scientific terms used herein have the same meaning as commonly understood by one of ordinary skill in the art to which this invention belongs. The systems, methods, and examples provided herein are illustrative only and not intended to be limiting.

In the description and claims of the present application, each of the verbs “comprise”, “include” and “have”, and conjugates thereof, are used to indicate that the object or objects of the verb are not necessarily a complete listing of members, components, elements or parts of the subject or subjects of the verb.

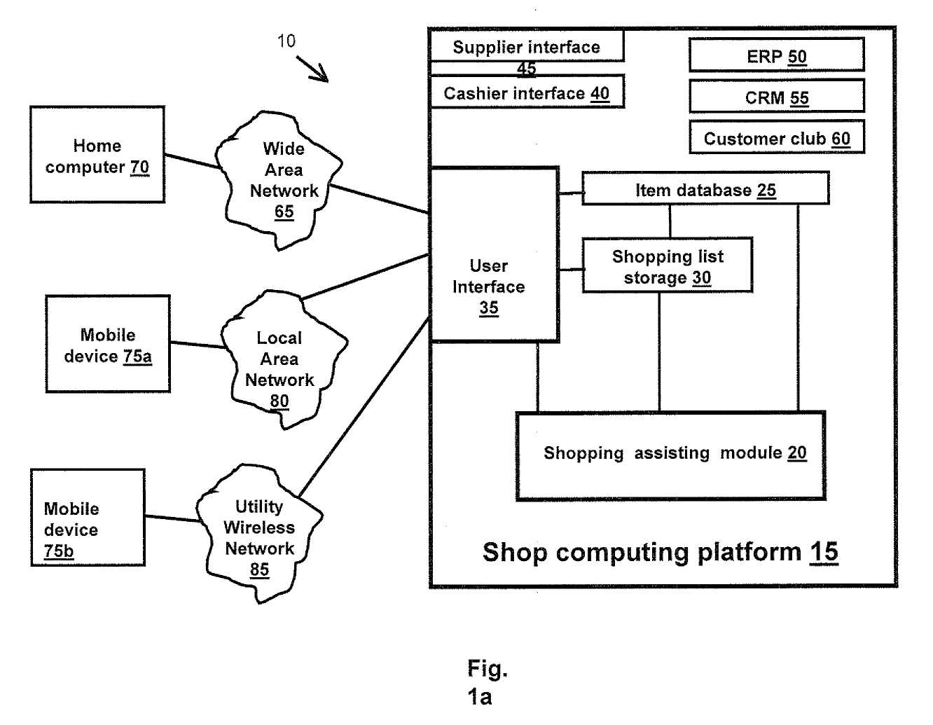

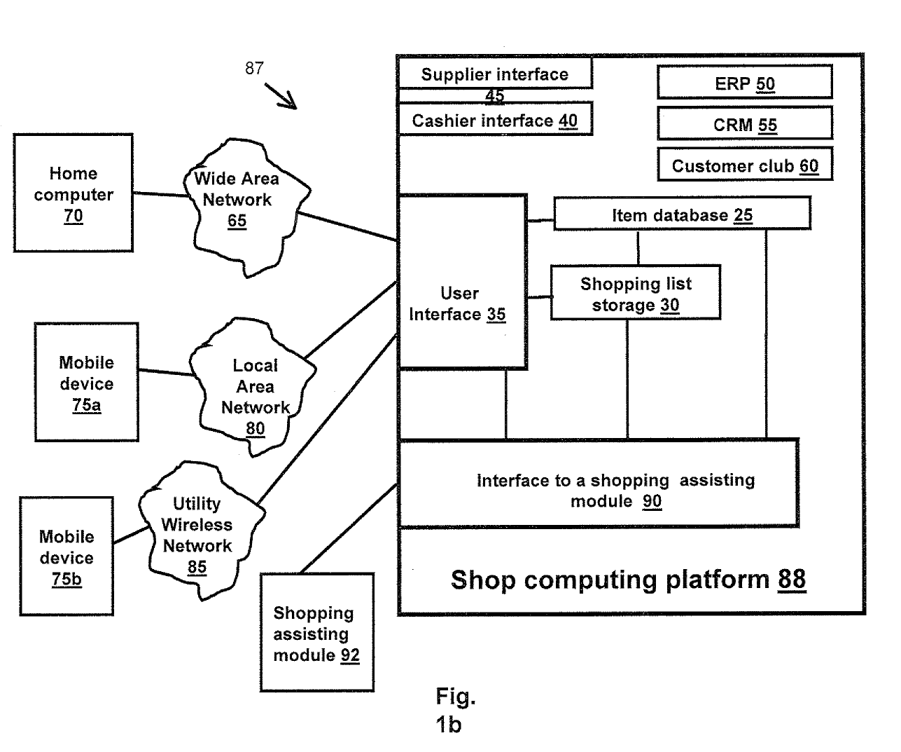

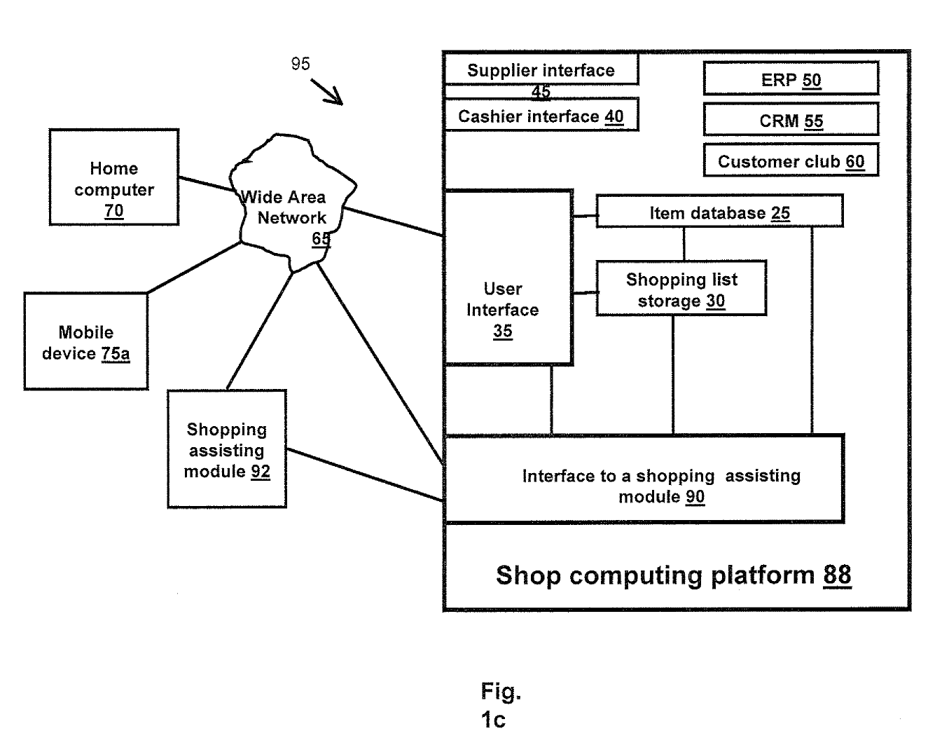

It is disclosed a system and method for supporting a shopper who wants to split her item collection to two tasks, one done by her personally in a shop with whatever possible support by the shop, and the other by a shop worker or associate which collects items for her, at least partially, in the same time she makes her item collection. A system 10 for that support is presented in the block diagram of FIG. 1a. A shop computing platform 15 includes a shopping assisting module 20, which is associated with an item database 25, with a shopping list storage 30 and with an user interface 35. The shop computing platform 15 includes also a cashier interface 40 a supplier interface 45, and may also include ERP(enterprise resource planning) module 50, CRM (customer relationship management) module 55 and customer club 60.

The shopping assistant module interacts through the internet 65 with a home computer 70 of a shopper using the user interface 35. Through such an interaction, a first shopping list for item collection by the shopper, and a second shopping list for item collection by a shop associate are achieved. For example, the user interface 35 may introduce the item database to a new shopper and the new shopper may designate items she wants to buy by one of two indications, one for the first shopping list and the second one for the second shopping list. Alternatively, the shopper may designate an indication for a desired item without any reference to the item collector. Later on, the splitting of a single list to two lists may be done using a special feature of the user interface 35. Similarly, a transfer from one list to other may be also be facilitated by the user interface 35.

Once the shopper is in the shop collecting items in accordance with the first shopping list, the shopping assisting module 92 may support that item collection in a variety of ways. It also affects printing of the second shopping list for use by a shop associate. If desired, it may affect printing of the first shopping list.

For that support the module may communicate with a mobile device 75a or 75b, respectively through a local area network (LAN) 80 or through a utility wireless network 85. In accordance with the connecting network the mobile device is a cellular telephone, a personal digital assistants (PDA), laptop computer, mobile media player, or a mobile device dedicated to assisting shoppers (PSA, personal shopping assistant). Such a mobile device 75a or 75b is adapted to managing a shopping list.

The PSA may be provided by the shop, either as a renting model, a present to repeating shoppers or temporally upon entrance to the shop. Alternatively, the PSA may be purchased at a variety of other places like other shops which adopt the technology.

Referring now to FIG. 1b, a system 87 includes an independent shopping assisting module 92 which interacts with the shop computing platform 88 through an interface 90. Yet, the interaction with the user is done through user interface 35.

In other embodiments, illustrated in FIG. 1c, shopping assisting module 92 is connected to a wide area network, and thus a shopper having a mobile device may interact directly with the shopping assisting module 92. Moreover, a shopper using mobile device 75a may interact with the shop computing platform 88 and with shopping assisting module through the internet 65, using for example the WAP (wireless application protocol).

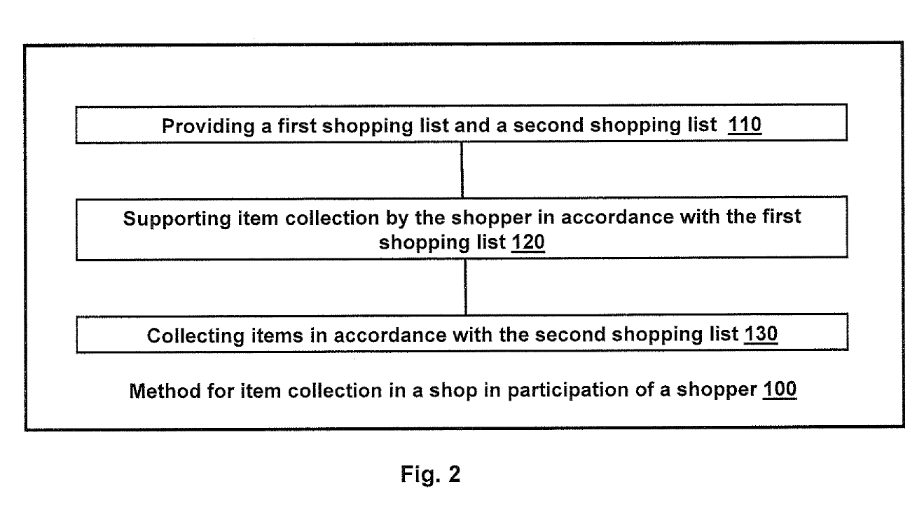

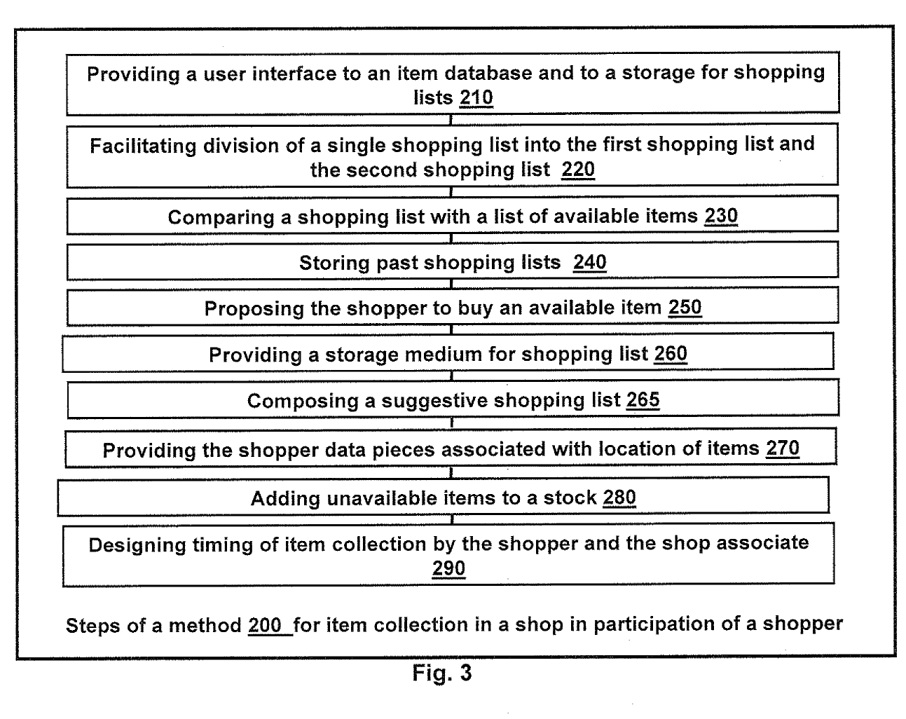

Before referring to FIGS. 2 and 3 which deal with methods, it should be understood that the steps of the method may be performed in any order or simultaneously, unless it is clear from the context that one step depends on another being performed first.

The flow chart of FIG. 2 illustrates a method 100 for item collection in a shop in participation of a shopper. The method 100 includes providing 110 a first shopping list and a second shopping list, supporting 120 item collection by the shopper in accordance with the first shopping list, and collecting 130 items in accordance with the second shopping list. The supporting is facilitated by the computerized platforms 15,70,75a and 75b.

FIG. 3 presents a flow chart which includes further steps of a method 200 for item collection in a shop in participation of a shopper. Method 200 includes providing 210 a user interface 35 to an item database 25 and to a storage 30 for shopping lists, whereby the storage 30 may contain past and planned shopping lists of the shopper.

The method also includes facilitating 220 division of a single shopping list into the first shopping list and the second shopping list.

In some embodiments, method 200 includes comparing 230 a shopping list with a list of available items. In addition, method 200 may include storing 240 a list of bought items in a storage 30 for shopping lists as a past shopping list.

In some embodiments, method 200 includes proposing 250 the shopper to buy an available item. Such a proposal may encourage sale of the available item in replacement of an unavailable item included in a shopping list. Also, it may remind items based on past shopping lists and/or support a promotion campaign for the item.

In some embodiments, the method 200 includes providing 260 at least one storage medium for storing a shopping list. The storage medium may be a piece of paper printed in the shop, or a memory stick to be inserted in a portable device 75a or 75b. The shopping list may be retrieved from the shop computing platform 15. Thus, the shopper gets the shopping list on an accessible medium for use while collecting items in the shop.

Method 200 may include composing 265 a suggestive shopping list in accordance with past shopping lists. By analysis of the past shopping lists, the shopping assisting module 20 and 92 determines a list of items a given consumer purchases frequently. This routine purchases list, which fits the frequency of buying various items, may be proposed to the shopper as a suggestive shopping list to be collected by the shop associate. For example, suppose that certain shopper buys two pounds rice package once a month. Then, three weeks after the previous buying of rice, the shopping assisting module 20 may introduce that package of rice in s suggestive shopping list. The past shopping lists are aggregated continuously where old past shopping lists get less attention and weight in evaluating the shopper habits.

While the shopper is walking over the shop floor looking for the items in the first shopping list, the step of providing 270 the shopper one or more data pieces associated with location of certain items, may be of great help, saving shopping time, and allowing more time to inspecting new items and paying attention to promotion campaigns.

The method 200 also includes proposing 250 the shopper to buy an available item in response to an item inquiry made by the shopper. The inquiries may deal with a clear description of the product (weight, ingredients, percentage fat, etc.), calculation and comparing of prices between competitive products (price per volume or per weight).

In some embodiments, the method includes adding 280 unavailable items to a stock in accordance with an expected visit time, planned shopping lists and past shopping list associated with a future visit of the shopper.

The supporting 120 of item collection by the shopper in accordance with the first shopping list, and the collecting 130 of items in accordance with the second shopping list are usually temporally overlapping. In other words, the shopper let the shop have the second shopping list and an approximate time of his arrival to collect items according to the first shopping list. The shop management may order an associate to collect items for the shopper half an hour or so before the planned visit of the shopper. Thus, the shopper may be consulted face to face once an item to be collected by the associate is unavailable, and an alternative item may be proposed 250 to her. More specifically, the method may include designing 290 the collecting items in accordance with the second shopping list to be substantially over once the item collection in accordance with the first shopping list is over. Thus, once the shopper arrives a cashier, the items collected for her/him are available for payment.

A computer program to apply the method 100 and method 200 may be stored in a program storage device readable by a computerized apparatus, tangibly embodying a program of instructions executable by the computerized apparatus to facilitate execution of the method 100 and 200.

Referring now to the shopper viewpoint, for a given purchase, the shopping assisting module 20 compares between the shopping lists, and the items actually purchased at checkout/cashier. This comparison helps to understand whether there were products the consumer wrote down in the first shopping list but the shopper didn't actually buy, for a variety of reasons, i.e. she forgot, she couldn't find them, out-of-stock, in storage but not on the shelves, price too high. A solution may be suggested to the consumer in real time while he is still in the shop by locating the product and bring it to the cashier, by suggesting an alternate product, etc. Moreover, by comparing the intended list with the actual purchase, and by further analysis, it is possible to learn about an inverse situation, namely what products had not been in the original shopping list, but were actually purchased. From that purchases the shopping assisting module 20 may derive conclusions regarding the consumer purchasing behavior, for example that she purchases products on sale, cheaper alternative products, ready to try new products, tempted by heavily advertised items, etc.

At the end of shopping process, a bill is issued and fed into shopping list storage 30 as a past shopping list. Note that for a new customer there are no past shopping lists. However, after two-three shop visits, the shopping assisting module 20 may obtain the data necessary to propose the second shopping list of routine purchases based on the few accumulated past shopping lists. Evidently, the shopper always has the option to update and/or modify the list.

The consumer's routine shopping list can be transmitted to the shop remotely by email or telephone, or the list can be received locally by its being submitting at the shop. The shopping list is fed into a computer and the “routine purchases” list (the above mentioned second list) may be printed and matched to the past shopping lists. The consumer may be offered a secretarial service, offering her additional products she typically purchases and perhaps forgot to write down. The consumer may adjust and change the list or may leave it unchanged. Subsequently, the shopper may divide the list into two parts: routine purchases in a first shopping list to be collected by the shopper and a second list to be collected by a shop associate. The two parts of the list may be printed and given to the consumer and to the shop associate, respectively.

Alternatively, the shopping lists are fed into a mobile electronic device, used by the item collector, the shopper and/or the shop associate. Dedicated software for making purchases with the electronic device may be used. A shopping list is fed into the device, the list is clearly displayed on the display, and is updated each time the consumer makes a purchase, and/or places an item in a shopping cart. The update may be done by manual deletion of a collected item from the list. Also, an electronic erasure of a product may be applied using methods and devices such as barcode reader or RFID (radio frequency identification card) reader or other methods and devices known in the art. The planned purchase ends when all of the products in the list are erased and the item collector knows that nothing has been forgotten.

Referring to the shop management viewpoint, by analyzing the data in storage 30 for all the shoppers, product stocks in the food chain/shop may be maintained with regard to customer purchasing behavior. For example, since it is known on what day of the week a consumer typically makes her purchases, it is possible to make sure that “routine purchase” items for a given consumer are available on the shelf for her.

The item database 25 may contain a map of product locations, thereby assisting the consumer to find products, suggesting an optimal navigational path (shortest, most interesting path, according to the consumer's personal preference such as a path including an ice cream at the end of the path, etc.).

Using a mobile device 75a or 75b, the consumer may be offered, during his purchase, additional products located proximate to collected items. For example, the consumer may be offered “hot” specials during a given time period. Also, other pieces of information may be delivered to the shopper, like a notice that item collection by the shop associate is over, and data on an event for club members.

In conclusion, the system and method of the present disclosure fit shoppers or consumers that visit the shop for their purchasing. The shop may suggest the visiting shoppers special item which they usually buy in a reduced cost using coupons, real or virtual_{—} Finally, the disclosure suggest for the first time an access to their shopping list, and may compare that shopping list to the actual bought items and thus may get insight about the shoppers and the items available in the shop.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. In particular, the present invention is not limited in any way by the examples described.

Claims:

1. A method for item collection in a shop in participation of a shopper and in support of one or more computerized platforms, the method comprising:
(a) providing a first shopping list and a second shopping list;
(b) supporting item collection by said shopper in accordance with said first shopping list, said supporting being facilitated by said one or more computerized platforms; and
(c) collecting items in accordance with said second shopping list.

2. The method of claim 1 wherein the method includes providing an user interface to an item database and to a storage for shopping lists, whereby the storage may contain past and planned shopping lists of said shopper.

3. The method of claim 1 wherein the method includes facilitating division of a single shopping list into said first shopping list and said second shopping list.

4. The method of claim 1 wherein the method includes comparing a shopping list with a list of available items.

5. The method of claim 1 wherein said method further includes the step of storing a list of bought items in a storage for shopping lists as a past shopping list.

6. The method of claim 1 wherein the method includes proposing said shopper to buy an available item, thereby encouraging sale of said available item in replacement of an unavailable item included in a shopping list, or reminding items based on past shopping lists or supporting a promotion campaign for items.

7. The method of claim 1 wherein the method includes providing at least one storage medium for storing a shopping list, said shopping list being retrieved from said one or more computerized platforms, whereby the shopper may thus get said shopping list on an accessible medium for use while collecting items in said shop.

8. The method of claim 1 wherein the method includes composing a suggestive shopping list in accordance with one or more past shopping lists.

9. The method of claim 1 wherein the method includes providing said shopper one or more data pieces associated with location of one or more items.

10. The method of claim 1 wherein the method includes proposing said shopper to buy an available item in response to an item inquiry made by said shopper.

11. The method of claim 1 wherein the method includes adding unavailable items to a stock in accordance with an expected visit time, planned shopping lists and past shopping list associated with a future visit of said shopper.

12. The method of claim 1 wherein said supporting and said collecting are temporally overlapping.

13. The method of claim 1 wherein the method includes designing said collecting items in accordance with said second shopping list to be substantially over once the item collection in accordance with said first shopping list is over, thereby once said shopper arrives a cashier, the items collected for the shopper are available for payment.

14. A program storage device readable by a computerized apparatus, tangibly embodying a program of instructions executable by the computerized apparatus to facilitate execution of the method of claim 1.

15. A shopping assisting module for item collection in a shop in participation of a shopper, the module being associated with an item database, with a storage for shopping lists and with an user interface, the module adapted for:
(i) interacting with a shopper using said user interface to provide a first shopping list and a second shopping list;
(ii) supporting item collection by said shopper in accordance with said first shopping list; and
(iii) outputting said second shopping list for use by an item collector.

16. The module of claim 15 wherein the module is further adapted to communicate with a mobile device in support of item collection by said shopper.

17. The module of claim 16 wherein said mobile device is selected from a group consisting of cellular telephones, personal digital assistants, laptop computers, mobile media players and mobile device dedicated to assisting shoppers.

18. The module of claim 16 wherein said mobile device is adapted to managing a shopping list.

19. A mobile device for assisting a shopper in item collection in a shop in support of a computerized platform, the item collection by said shopper being made in temporal overlapping with item collection for said shopper by a shop associate, the mobile device adapted for interacting with said computerized platform regarding at least:
(a) one or more shopping lists;
(b) one or more item location;
(c) item selection by said shop associate; and
(d) suggestion of available item in replacement of an unavailable item.

20. The mobile device of claim 19 wherein the mobile device is interacting with said computerized platform using a local area network.
